(19) United States
(12) Patent Application Publication
(10) Pub. No.: US 2005/0234991 A1
(43) Pub. Date: Oct. 20, 2005

(54) Automated location indexing by natural language correlation

(76) Inventors: Peter Samuel Marx, Los Angeles, CA (US); Ahti Alan Hujanen, Oakdale, MN (US); Mayer Alan Brenner, Los Angeles, CA (US)

Correspondence Address: HOGAN & HARTSON L.L.P., 500 S. GRAND AVENUE, SUITE 1900, LOS ANGELES, CA, 90071-2611, US

(21) Appl. No.: 10/980,043

(22) Filed: Nov. 3, 2004

Related U.S. Application Data
(60) Provisional application No. 60/518,561, filed on Nov. 7, 2003.

(51) Int. Cl. G06F 7/00

(52) U.S. Cl. 707/104.1

(57) ABSTRACT

The present invention provides a parser that “reads” web pages and other computer-based information sources to correlate place names to locations, and then convert those locations to longitude and latitude coordinates for use in location services.

### RELATED APPLICATIONS

This application claims the benefit of U.S. provisional application Ser. No. 60/518,561, filed Nov. 7, 2003.

### BACKGROUND OF THE INVENTION

1. Field of the Invention

The present invention relates in general to location services, and in particular to automated location indexing by natural language correlation.

2. Description of the Related Art

The current expansion of Global Positioning System (GPS) technology into mobile platforms creates new opportunities for location services. For example, people can now use their cellular telephones, Personal Data Assistants (PDAs), and other mobile computing devices to locate restaurants, businesses, and other places of interest.

However, to be able to locate such places, the system must have longitude and latitude information for each business or place that a person is trying to locate. A street address, for example, which is used to locate a business on a map, is not necessarily easily correlated to a given latitude and longitude by a given mobile platform. Further, many data sources, such as web pages on the Internet, do not contain latitude and longitude information. As such, users of location services are not able to always locate a desired place or business.

It can be seen, then, that there is a need in the art for a method and apparatus that can convert place names to latitude and longitude information. It can also be seen that there is a need in the art for a straightforward way to convert place names to latitude and longitude information.

### SUMMARY OF THE INVENTION

To minimize the limitations in the prior art, and to minimize other limitations that will become apparent upon reading and understanding the present specification, the present invention discloses a method and apparatus for converting typical place names to longitude and latitude information.

The present invention provides a parser that “reads” web pages and other computer-based information sources to correlate place names to locations, and then convert those locations to longitude and latitude coordinates for use in location services. The present invention scans through pre-existing and new documents looking for place names and/or other location references and uses those references to assign location coordinates to the reference. In its scanning process, the present invention uses a pre-built library of words and phrases often associated with places, including actual place names as well as directions (e.g. “northeast of”), proximity (e.g. “near” or “across from”), and so forth. When such words and phrases are identified within a document, the invention attempts to derive a specific location which can be cross-referenced with a data base that correlates place names with latitude and longitude. The invention recursively operates on the document to extract the most specific place location possible (e.g. the latitude and longitude of “Hollywood and Vine” rather than the general location of “Hollywood, Calif.”).

It is an object of the present invention to convert place names to latitude and longitude information. It is another object of the present invention to provide a straightforward way to convert place names to latitude and longitude information.

### BRIEF DESCRIPTION OF THE DRAWINGS

Referring now to the drawings in which like reference numbers represent corresponding parts throughout:

FIG. 1 illustrates a system in accordance with the present invention.

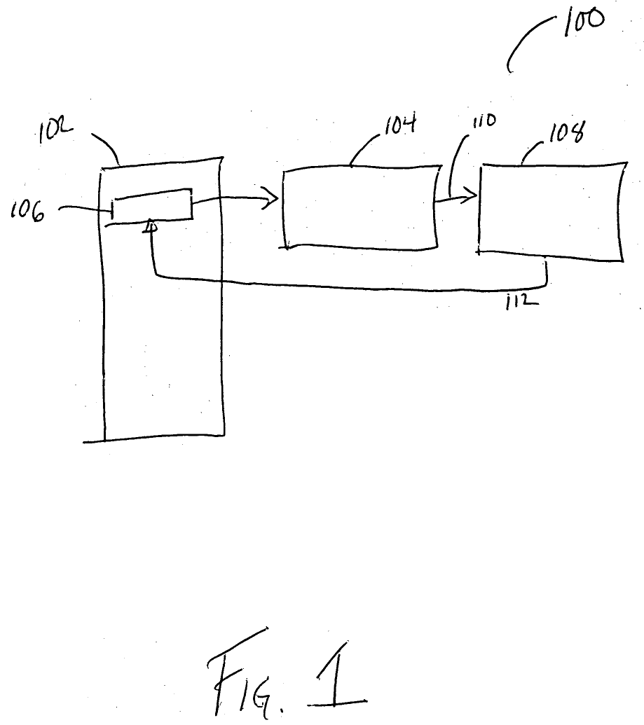

### DETAILED DESCRIPTION OF THE DRAWINGS

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

Overview

Using GPS and other location technologies, new categories of location-based services are now feasible. Such location-based services will allow real-time access to information that is correlated to a location. Information may be created or modified specifically for use by such a system.

However, location-based services achieve their greatest utility by taking advantage of the existing vast world of data sources (such as the 3,000,000,000+ extant web pages). These existing data could be provided in a location-based context once the content has been correlated to location (e.g. latitude and longitude).

Structured information in existing documents often contains sufficient data to identify the location to which the data in the document refers. For example, news articles typically include a “dateline” reference identifying the city from which the report is filed. By analyzing such places referred to in a document, the location or locations to which the document refers may be extracted.

The present invention proposes a method of automatically identifying location references in structured documents. This method correlates all place references from a given document to derive a “high quality” index based on location. Furthermore, the present invention proposes a method to allow newly generated documents to be tagged and indexed in a standardized manner at the time of creation, so that location-based services may look up location information contained in them without the need for further interpretation or extraction.

Automatic Location Identification of Existing References

The present invention uses a database in conjunction with a character string identifier to locate and evaluate place names within a reference. System 100 illustrates a database 102 and character string identifier 104, which accepts an entry 106 from database 102 for review.

Character string identifier 104 reviews entry 106 and, uses correlator 108 to review potential location entries 110 found in entry 106. Correlator 108 then determines which of the location entries 110 are proper, and determines an overall “location” for entry 106. Entry 106 is then tagged within database 102 as associated with a given location, i.e., tagged with a specific longitude and latitude. Typically, the correlator will use multiple iterations to attempt to extract and refine any location information in the document. Divergence or convergence in the iterative location information can be used to provide accuracy or proximal qualifiers to the location index.

As an example, and not by way of limitation of the present invention, an Internet article about Thomas Jefferson will likely mention his home, Monticello, which is located in Charlottesville, Va. The article may also mention George Washington and Mr. Washington's home in Mount Vernon, James Madison and his home Montpelier in Orange, Va., James Monroe and his home Ash Lawn-Highland, also located in Charlottesville, Va., and other founding fathers.

The article is an entry 106 in the database 102 of servers that support and store Internet-based information. If so, the references to “Charlottesville,” “Mount Vernon,” and “Orange” will be identified as potential locations by character string identifier 104, and passed along as location entries 110 to correlator 108.

Correlator 108 will then determine which location the story (entry 106) is likely about, through other references such as the title of the web page or other location clues. For example, the title of the web page may say “Thomas Jefferson” somewhere in the title, which would give clues to correlator 108 that the article is likely about Mr. Jefferson, and therefore is more likely to be associated with Charlottesville than with Mount Vernon or Orange, Va. Further, some web pages have “datelines” that state a location for the story, which correlator 108 would use for assigning locations to entries 106. Once a location 112 for entry 106 is determined, it is appended or otherwise associated with that entry 106 for use by location services.

Once correlator 108 determines which location entry 106 should be associated with, correlator 108 then tags entry 106, i.e., the story about Thomas Jefferson, with a longitude and latitude for Charlottesville, Va., i.e., 38° 2′ North latitude, 78° 31′ West longitude, so that when a user of location services is in or nearby Charlottesville, they will have ready access to this entry 106. In essence, the correlator 108 relates entry 106 to a location. Typically, the location is given in longitude and latitude coordinates, but can be expressed in other terms.

Users have an optional opportunity to change the location by manual intervention into correlator 108. For example, if a user determines that a given entry 106 is inappropriately associated with a given location, the user can change the field in the database that reports location to a new location. To continue the above example, if correlator 108 associated the Thomas Jefferson entry with Mount Vernon, the user can send a message to database 102, or directly to correlator 108, that the entry 106 should be associated with Charlottesville, and correlator 108 and/or database 102 would re-assign the location for that entry 106 to Charlottesville, Va.

Tagging and Indexing of New References

As above, any new entry 106 references that are generated can be placed into system 100 and a location reference can be generated and appended to each entry 106. Further, each author of an entry 106 can place a location name, e.g., Charlottesville, Va. in a “dateline” field in an entry to. assist system 100 in providing location tags for each new entry 106 in database 102.

Multiple location references are possible within system 100. Again, using the above example, the above story entry 106 can have a preferred location of Charlottesville, Va., because the main topic of the story relates to Thomas Jefferson and Charlottesville. However, the story entry 106 also relates to George Washington and James Madison, and therefore may be of interest to visitors of Mount Vernon or Orange, Va. as well. System 100 can store several location entries associated with each story, and provide a relative weighting or score to give users the ability to view other items about the entry 106, e.g., tide, abstract, first paragraph of the entry 106, to allow users to determine whether the entry 106 is useful to them.

Advantages of Location Tagging

The biggest problem with location services is that each overall system, e.g., PDA support, cellular telephone providers, blackberry use, etc., is dependent on that system's database. Although the Internet is accessible by all of these platforms, no current methodology exists to convert Internet data into location data. The present invention provides a methodology for all platforms to use existing Internet data for location services.

Further, system 100 of the present invention uses natural language indexing of entries 106. Instead of forcing users to know where they are, system 100 correlates place names, e.g., Charlottesville, Va., to longitude and latitude coordinates, and vice versa, so that users can enter queries in a natural language format and receive results based on a natural language format. This makes system 100 more user-friendly than cumbersome and unfamiliar longitude and latitude coordinates that many users would find unwieldy.

Conclusion

In summary, the present invention provides a system and method for tagging and correlating computer data for use in location services systems. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description.

1. A method for automatically indexing computer-based information sources by location comprising:
extracting location references from the information sources;
converting the location references into longitude and latitude coordinates; and
tagging the information sources with the longitude and latitude coordinates.

2. A method as claimed in claim 1, wherein the information sources comprise Internet web sites.

3. A method as claimed in claim 1, wherein natural language correlation is used to extract the location references.

4. A method as claimed in claim 1, wherein multiple iterations are used to extract and refine location references in the information sources.

5. A method as claimed in claim 1, wherein a single information source may be tagged with multiple longitude and latitude coordinates.

6. A method as claimed in claim 5, wherein the multiple longitude and latitude coordinates are each assigned a relative weighting.

7. A method as claimed in claim 1, wherein newly generated information sources are tagged at their creation to allow the location references contained in them to be accessed without need for further extraction or conversion.

8. A method as claimed in claim 1, wherein the location references are extracted from dateline fields of the information sources.

9. A location indexing system comprising:
a character string identifier that accepts a document from a database for review; and
a correlator that reviews potential location entries found in the document, determines which of the potential location entries are proper, determines an overall location for the document, and tags the document as associated with the location.

10. A system as claimed in claim 9, wherein the document is tagged with longitude and latitude coordinates.

11. A system as claimed in claim 9, wherein the document is a web page.

12. A system as claimed in claim 9, and further comprising means for a user to change the location associated with a document by manual intervention into the correlator.

13. A system as claimed in claim 9, wherein a single document may be tagged with multiple locations.

14. A system as claimed in claim 13, wherein the multiple locations are each assigned a relative weighting or score.

15. A system as claimed in claim 9, wherein natural language correlation is used to review the document for location entries.

16. A parser that reads web pages and other computer-based information sources and correlates place names to locations, and converts the locations into longitude and latitude coordinates for use in location services.
